(19) United States
(12) Patent Application Publication
(10) Pub. No.: US 2016/0138709 A1
(43) Pub. Date: May 19, 2016

(54) METHOD OF DIAGNOSING MALFUNCTION IN DUAL CLUTCH TRANSMISSION

(71) Applicants: Hyundai Motor Company, Seoul (KR); Kia Motors Corp., Seoul (KR)

(72) Inventors: Young Min YOON, Suwon-si (KR); Seung Sam BAEK, Jeju-si (KR)

(73) Assignees: Hyundai Motor Company, Seoul (KR); Kia Motors Corp., Seoul (KR)

(21) Appl. No.: 14/717,223

(22) Filed: May 20, 2015

(30) Foreign Application Priority Data
Nov. 19, 2014 (KR) 10-2014-0161318

(51) Int. Cl. F16H 61/12

(52) U.S. Cl. CPC F16H 61/12; F16H 2061/1284; F16H 2061/1272; F16H 2061/009

(57) ABSTRACT

A method of diagnosing a malfunction in a dual clutch transmission may include determining, by a controller, a difference between a first input speed and a wheel speed output by reflecting a transmission gear ratio on the first input speed, and determining by the controller, a difference between a second input speed and a wheel speed output by reflecting the transmission gear ratio on the second input speed, when the difference between the first input speed and the wheel speed output by reflecting the transmission gear ratio on the first input speed is greater than a first reference value and the difference between the second input speed and the wheel speed output by reflecting the transmission gear ratio on the second input speed is equal to or smaller than a second reference value, diagnosing a first input shaft as having a transmission gear synchromesh failure.

### CROSS REFERENCE TO RELATED APPLICATION

The present application claims priority of Korean Patent Application Number 10-2014-0161318 filed on Nov. 19, 2014, the entire contents of which application are incorporated herein for all purposes by this reference.

### BACKGROUND OF THE INVENTION

1. Field of the Invention

The present invention relates to a method of diagnosing a malfunction in a transmission due to a synchromesh failure in a vehicle equipped with a dual clutch transmission (DCT).

2. Description of Related Art

Recently, significant development has been made in automated manual transmissions, such as a dual clutch transmission (DCT), so as to realize the driving comfort of automatic transmissions and the high fuel efficiency and the high power efficiency of manual transmissions.

A DCT is a system based on a manual transmission in which the operation of a clutch and gear changes are automated. These operations are enabled using an actuator that is driven by oil pressure or with a motor.

FIG. 1 schematically illustrates a partial configuration of a power train of a vehicle equipped with a DCT. Referring to FIG. 1, a first input shaft speed sensor 1 and a second input shaft speed sensor 3 are respectively provided on a first input shaft and a second input shaft, and an output shaft speed sensor 5 is provided on an output shaft. With these parts, it is possible to diagnose a synchromesh failure in a gear that is to form a shifting position.

A gear synchromesh failure in either the first input shaft or the second input shaft is diagnosed by comparing the output shaft speed produced based on the first input shaft speed and the output shaft speed produced based on the second input shaft speed.

However, this approach necessarily requires an output shaft speed sensor in order to diagnose a malfunction due to the gear synchromesh failure.

In this case, it may be required to diagnose a malfunction in the transmission using a wheel speed sensor. However, since the wheel speed sensor receives a signal from a chassis controller via controller area network (CAN) communication, a transmission control unit (TCU) is unaware of the state of the reliability of the diagnosis. Accordingly, it is difficult to diagnose a malfunction in the transmission using only the signal input from the wheel speed sensor.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of diagnosing a malfunction in a dual clutch transmission (DCT) able to diagnose a malfunction due to a gear synchromesh failure without an output shaft speed sensor and improve the reliability of the result of the malfunction diagnosis.

In an aspect of the present invention, there is provided a method of diagnosing a malfunction in a DCT, including, calculating a difference between a first input speed and a wheel speed output by reflecting a transmission gear ratio on the first input speed, calculating a difference between a second input speed and a wheel speed output by reflecting the transmission gear ratio on the second input speed, and when the difference between the first input speed and the wheel speed output by reflecting the transmission gear ratio on the first input speed is greater than a first reference value and the difference between the second input speed and the wheel speed output by reflecting the transmission gear ratio on the second input speed is equal to or smaller than a second reference value, diagnosing a first input shaft as having a transmission gear synchromesh failure.

According to an exemplary embodiment of the present invention, the method may further include: when the difference between the first input speed and the wheel speed output by reflecting the transmission gear ratio on the first input speed is greater than the first reference value, and the difference between the second input speed and the wheel speed output by reflecting the transmission gear ratio on the second input speed is greater than the second reference value, calculating a difference between an output produced by reflecting a first input shaft speed and a corresponding transmission gear ratio and an output produced by reflecting a second input shaft speed and a corresponding transmission gear ratio, and when the difference between the output produced by reflecting the first input shaft speed and the corresponding transmission gear ratio and the output produced by reflecting the second input shaft speed and the corresponding transmission gear ratio is greater than a third reference value, diagnosing the first input shaft and the second input shaft as having a transmission gear synchromesh failure.

The method may further include, when the difference between the second input shaft speed and the output value produced by reflecting the transmission gear ratio on the second input shaft speed is equal to or smaller than the third reference value, diagnosing a wheel speed sensor as malfunctioning.

The method may further include, when the difference between the first input speed and the wheel speed output by reflecting the transmission gear ratio on the first input speed is equal to or smaller than the first reference value, diagnosing neither the first input shaft nor the second input shaft as having a transmission gear synchromesh failure.

The method may further include, before calculating the difference between the first input speed and the wheel speed output by reflecting the transmission gear ratio on the first input speed, receiving a first input shaft speed, a second input shaft speed and a wheel speed as inputs via a first input shaft speed sensor, a second input shaft speed sensor and a wheel speed sensor.

The method may further include judging transmission gear pre-engagement of the second input shaft after calculating the difference between the first input speed and the wheel speed output by reflecting the transmission gear ratio on the first input speed, and before calculating the difference between the second input speed and the wheel speed output by reflecting the transmission gear ratio on the second input speed.

As set forth above, the present invention makes it possible to diagnose a transmission gear synchromesh failure using a wheel speed sensor that measures the vehicle speed without an output shaft speed sensor as well as diagnose a malfunction in the wheel speed sensor in the process of diagnosing the transmission gear synchromesh failure. It is therefore possible to improve the reliability of the wheel speed sensor used for synchromesh failure diagnosis as well as the reliability of the result of the malfunction diagnosis using the wheel speed sensor.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view schematically illustrating the configuration of a part of a power train of a vehicle equipped with a DCT.

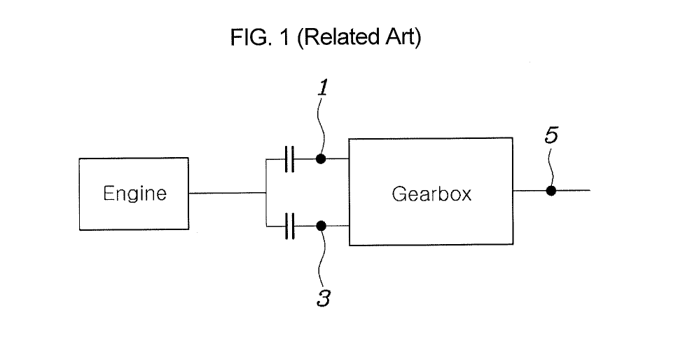

FIG. 2 is a flowchart illustrating a method of diagnosing a malfunction in a DCT according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The method of diagnosing a malfunction in a DCT according to an exemplary embodiment of the present invention includes first calculation step S20, second calculation step S40 and first malfunction diagnosis step S60.

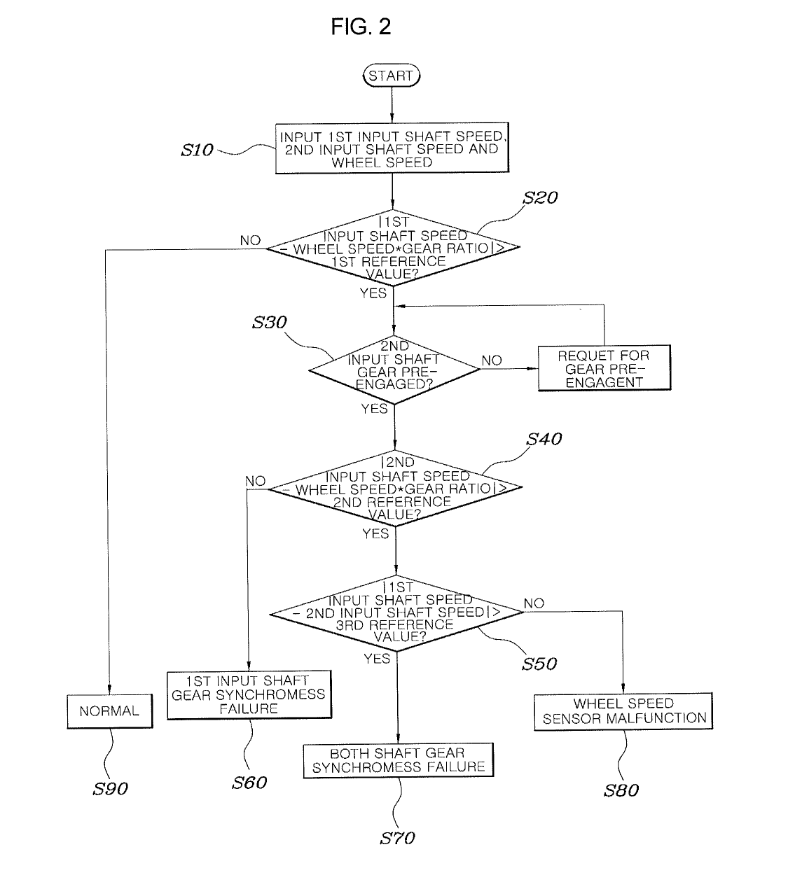

The method will be described in greater detail with reference to FIG. 2. At the first calculation step S20, the difference between a first input shaft speed and a wheel speed output by reflecting a transmission gear ratio on the first input shaft speed is calculated.

At input step S10 prior to the first calculation step S20, the first input shaft speed may be input into a controller, for example, a transmission control unit (TCU) by being measured by a first input shaft speed sensor disposed on a first input shaft, and the wheel speed may be input by being measured by a wheel speed sensor. The difference may be an absolute value.

For example, when a pair of gears for forming a first shifting position are engaged with the first input shaft and the output shaft and rotate as a driving shaft, the first input shaft speed is calculated by multiplying the wheel speed with a first gear ratio.

Subsequently, the first input shaft speed calculated in this manner is compared with the first input shaft speed measured by the first input shaft speed sensor.

In this case, when the unit of a speed (vehicle speed) measured by a wheel speed sensor is different from the unit of the first input shaft speed, the rolling radius of the tire of the vehicle may be used in the calculation of the first input shaft speed in order to convert the units to be the same.

In addition, the method may also include judgment step S30 between the first calculation step S20 and the second calculation step S40. At the judgment step S30, it is judged whether or not a second input shaft is subjected to gear pre-engagement.

For example, in order to diagnose a transmission gear synchromesh failure caused by a synchronization device disposed on each input shaft during the operation of the vehicle, the transmission gear is required to be pre-engaged with the second input shaft, i.e. a released shaft in the state in which power is being provided through the first input shaft from the engine, by means of the synchronization device. Subsequently, the second input shaft functions as a driving shaft through DCT shifting. In this manner, the second calculation step S40 that will be described later can be carried out.

At the second calculation step S40, the difference between a second input shaft speed and a wheel speed output by reflecting a transmission gear ratio on the second input shaft speed is calculated.

At input step S10 prior to the second calculation step S20, the second input shaft speed may be input into the TCU by being measured by a second input shaft speed sensor disposed on the second input shaft. The difference may be an absolute value.

For example, when a pair of gears for forming a second shifting position are engaged with the second input shaft and the output shaft and rotate as a driving shaft, the second input shaft speed is calculated by multiplying the wheel speed with a second gear ratio.

Subsequently, the second input shaft speed calculated in this manner is compared with the second input shaft speed measured by the second input shaft speed sensor.

At the first malfunction diagnosis step S60, when the difference calculated at the first calculation step S20 is greater than a first reference value and the difference calculated at the second calculation step S40 is equal to or smaller than a second reference value, the first input shaft is diagnosed as having a transmission gear synchromesh failure.

Each of the first reference value and the second reference value is a tolerance between an input shaft speed value measured by the input shaft speed sensor and an input shaft speed value reversely calculated based on a wheel speed value measured by the wheel speed sensor. The first reference value and the second reference value may be set equal.

According to the above-described configuration, when the difference calculated at the first calculation step S20 is greater than the first reference value, the synchronization device engaged with the first input shaft may be suspected of having a transmission gear synchromesh failure. When the difference calculated at the second calculation step S40 is equal to or smaller than the second reference value, it is assumed that the wheel speed sensor is normally sensing the wheel speed. Accordingly, it is diagnosed as a malfunction due to the transmission gear synchromesh failure of the first input shaft.

In addition, the method according to the present exemplary embodiment may further include normality diagnosis step S90 of diagnosing both the first input shaft and the second input shaft as being normal when the difference calculated at the first calculation step S20 is equal to or smaller than the first reference value.

Furthermore, the method according to the present exemplary embodiment may further include third calculation step S50, second malfunction diagnosis step S70 and third malfunction diagnosis step S80.

At the third calculation step S50, when the difference calculated at the first calculation step S20 is greater than the first reference value and the difference calculated at the second calculation step S40 is greater than second reference value, the difference between an output produced by reflecting the first input shaft speed and a corresponding transmission gear ratio and an output produced by reflecting the second input shaft speed and a corresponding transmission gear ratio is calculated.

For example, the output at the output shaft may be calculated by multiplying the first input shaft speed with the transmission gear ratio of the pair of gears connected to the first input shaft. The output at the output shaft may be calculated by multiplying the second input shaft speed with the transmission gear ratio of the pair of gears connected to the second input shaft.

Consequently, at the second malfunction diagnosis step S70, when the difference calculated at the third calculation step S50 is greater than the third reference value, both the first input shaft and the second input shaft are diagnosed as having a transmission gear synchromesh failure.

Specifically, in the state in which the transmission gears are engaged with the first input shaft and the second input shaft, when there is no transmission gear synchromesh failure, the output produced using the first input shaft speed and the output produced using the second input shaft speed must be substantially equal within a tolerance.

When the transmission gears of either the first input shaft or the second input shaft have a synchromesh failure, the input shaft speed of the input shaft having a synchromesh failure may be slower than the input shaft speed measured at the normal state. Consequently, the output produced using the first input shaft speed is different from the output produced using the second input shaft speed.

Therefore, when the difference between the output produced using the first input shaft speed and the output produced using the second input shaft speed is greater than the third reference value, not only the first input shaft but also the second input shaft is diagnosed as having a transmission gear synchromesh failure.

At the third malfunction diagnosis step S80, when the difference calculated at the third calculation step S50 is equal to or smaller than the third reference value, the wheel speed sensor is diagnosed as malfunctioning.

When there is no transmission gear synchromesh failure, the output produced using the first input shaft speed is substantially equal to the output produced using the second input shaft speed within a tolerance. In this case, the wheel speed sensor is diagnosed as malfunctioning rather than the transmission gears.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of diagnosing a malfunction in a dual clutch transmission, including,
determining, by a controller, a difference between a first input speed and a wheel speed output by reflecting a transmission gear ratio on the first input speed; and
determining by the controller, a difference between a second input speed and a wheel speed output by reflecting the transmission gear ratio on the second input speed,
when the difference between the first input speed and the wheel speed output by reflecting the transmission gear ratio on the first input speed is greater than a first reference value and the difference between the second input speed and the wheel speed output by reflecting the transmission gear ratio on the second input speed is equal to or smaller than a second reference value, diagnosing a first input shaft as having a transmission gear synchromesh failure.

2. The method according to claim 1, further including:
when the difference between the first input speed and the wheel speed output by reflecting the transmission gear ratio on the first input speed is greater than the first reference value, and the difference between the second input speed and the wheel speed output by reflecting the transmission gear ratio on the second input speed is greater than the second reference value, determining a difference between an output produced by reflecting a first input shaft speed and a corresponding transmission gear ratio and an output produced by reflecting a second input shaft speed and a corresponding transmission gear ratio, and
when the difference between the output produced by reflecting the first input shaft speed and the corresponding transmission gear ratio and the output produced by reflecting the second input shaft speed and the corresponding transmission gear ratio is greater than a third reference value, diagnosing the first input shaft and the second input shaft as having a transmission gear synchromesh failure.

3. The method according to claim 2, further including, when the difference between the second input shaft speed and the output value produced by reflecting the transmission gear ratio on the second input shaft speed is equal to or smaller than the third reference value, diagnosing a wheel speed sensor as malfunctioning.

4. The method according to claim 1, further including, when the difference between the first input speed and the wheel speed output by reflecting the transmission gear ratio on the first input speed is equal to or smaller than the first reference value, diagnosing neither the first input shaft nor the second input shaft as having a transmission gear synchromesh failure.

5. The method according to claim 1, further including, before determining the difference between the first input speed and the wheel speed output by reflecting the transmission gear ratio on the first input speed, receiving a first input shaft speed, a second input shaft speed and a wheel speed as inputs via a first input shaft speed sensor, a second input shaft speed sensor and a wheel speed sensor.

6. The method according to claim 1, further including judging transmission gear pre-engagement of the second input shaft after determining the difference between the first input speed and the wheel speed output by reflecting the transmission gear ratio on the first input speed, and before determining the difference between the second input speed and the wheel speed output by reflecting the transmission gear ratio on the second input speed.
